(19) United States
(12) Patent Application Publication
(10) Pub. No.: US 2024/0364682 A1
(43) Pub. Date: Oct. 31, 2024

(54) VEHICLE UTILIZATION SYSTEM, FIRST SERVER OF VEHICLE UTILIZATION SYSTEM, AND VEHICLE UTILIZATION METHOD

(71) Applicant: DENSO CORPORATION, Kariya-city (JP)

(72) Inventors: Kazuya Yamada, Kariya-city (JP); Masayuki Kondo, Kariya-city (JP)

(21) Appl. No.: 18/765,947

(22) Filed: Jul. 8, 2024

Related U.S. Application Data
(63) Continuation of application No. PCT/JP2022/047692, filed on Dec. 23, 2022.

(30) Foreign Application Priority Data
Jan. 25, 2022 (JP) 2022-009431

(51) Int. Cl. H04L 9/40; G06F 9/54

(52) U.S. Cl. CPC H04L 63/083; G06F 9/547

(57) ABSTRACT

A vehicle utilization system includes a first server and a second server connected to each other. An authorization policy defining a vehicle function and a condition is registered in the first server. Upon receiving an authorization request for the vehicle function from an external server along with an execution condition, the first server stores the execution condition and an authorization policy, and transmits the authorization request to the second server. Upon accepting the authorization request, the second server obtains authorization for the vehicle function and issues a second access token. The first server holds the second access token and issues a first access token, and upon receiving a request for execution along with the first access token, the first server determines whether the execution condition is satisfied, and when the execution condition is satisfied, the first server requests the second server to instruct execution of the vehicle function.

### CROSS REFERENCE TO RELATED APPLICATION

The present application is a continuation application of International Patent Application No. PCT/JP2022/047692 filed on Dec. 23, 2022 which designated the U.S. and claims the benefit of priority from Japanese Patent Application No. 2022-009431 filed on Jan. 25, 2022. The entire disclosures of all of the above applications are incorporated herein by reference.

### TECHNICAL FIELD

The present disclosure relates to a system and method for utilizing a vehicle through the use of an application programming interface (API), and a first server used in the system.

### BACKGROUND

Original equipment manufacturers (OEMs) are assumed to provide APIs for service operators to use, based on the premise of the use of mobility as a service (MaaS) that is provided for vehicles. This enables vehicle driving, including vehicle door locking/unlocking, engine start, car navigation system setting, and operations such as trunk unlocking, all via the Web. Such an API is assumed to provide access control equivalent to existing web APIs like OpenID Connect (OIDC)/OAuth 2.0. In that case, only simple control authorization is possible for the requested function.

### SUMMARY

The present disclosure describes a vehicle utilization system including a first server and a second server connected to each other. An authorization policy defining a vehicle function and a condition is registered in the first server. Upon receiving an authorization request for the vehicle function from an external server along with an execution condition, the first server stores the execution condition and an authorization policy, and transmits the authorization request to the second server. Upon accepting the authorization request, the second server obtains authorization for the vehicle function and issues a second access token. The first server holds the second access token and issues a first access token, and upon receiving a request for execution along with the first access token, the first server determines whether the execution condition is satisfied, and when the execution condition is satisfied, the first server requests the second server to instruct execution of the vehicle function.

### BRIEF DESCRIPTION OF DRAWINGS

The above and other objects, features and advantages of the present disclosure will become more apparent from the following detailed description made with reference to the accompanying drawings. In the drawings:

FIG. 1 is a functional block diagram showing a configuration of a vehicle utilization system in a first embodiment;

FIG. 2 is a diagram showing an example of an authorization policy catalog;

FIG. 3 is a diagram showing an example in which an authorization policy is implemented;

FIG. 4 is a sequence diagram (part 1) showing a process between a vehicle owner, each server, and a vehicle in the case of application to a trunk service;

FIG. 5 is a sequence diagram (part 2) showing the process between the vehicle owner, each server, and the vehicle in the case of application to the trunk service;

FIG. 6 is a sequence diagram (part 3) showing the process between the vehicle owner, each server, and the vehicle in the case of application to the trunk service;

FIG. 7 is a sequence diagram (part 1) showing a process among a shared-car user, each server, and a vehicle in the case of application to a car-sharing service in a second embodiment; and

FIG. 8 is a sequence diagram (part 2) showing the process between the shared-car user, each server, and the vehicle in the case of application to the car-sharing service.

### DETAILED DESCRIPTION

When service operators deploy services using APIs such as those described above, there are assumed to be cases where the service operators wish to perform more detailed access control based on factors such as a date and time and a location according to the service contents. However, when service operators try to implement such access control, complex work is required, which is an obstacle for service operators to develop business.

The present disclosure provides a vehicle utilization system and method that enable a service operator to more easily provide a service including more detailed access control through the use of an API, and is to provide a first server used in the system.

According to a vehicle utilization system, an authorization policy defining a vehicle function and a condition for executing the vehicle function is registered in advance in the first server. Upon receiving an authorization request for the vehicle function from an external server that provides a service along with an execution condition for the service, the first server stores the execution condition and an authorization policy corresponding to the service in association with each other, and transmits the authorization request for the vehicle function to the second server.

Upon accepting the authorization request, the second server obtains authorization for the vehicle function and then issues a second access token to the first server.

The first server holds the second access token and issues, to the external server, a first access token associated with the second access token, the execution condition, and the authorization policy, and upon receiving a request for execution of the service along with the first access token from the external server or a user who uses the service, the first server determines whether the execution condition is satisfied according to the execution condition and the authorization policy associated with the first access token, and when the execution condition is satisfied, the first server requests the second server to instruct execution of the vehicle function along with the second access token.

According to the configuration, a business operator that provides a service using the external server as a user reception point can set a detailed execution condition for the service through the first server. Since the first server intermediates the authorization request for the vehicle function to the second server, the business operator providing the service does not need to perform a complex process in the external server, and can easily develop the business.

### First Embodiment

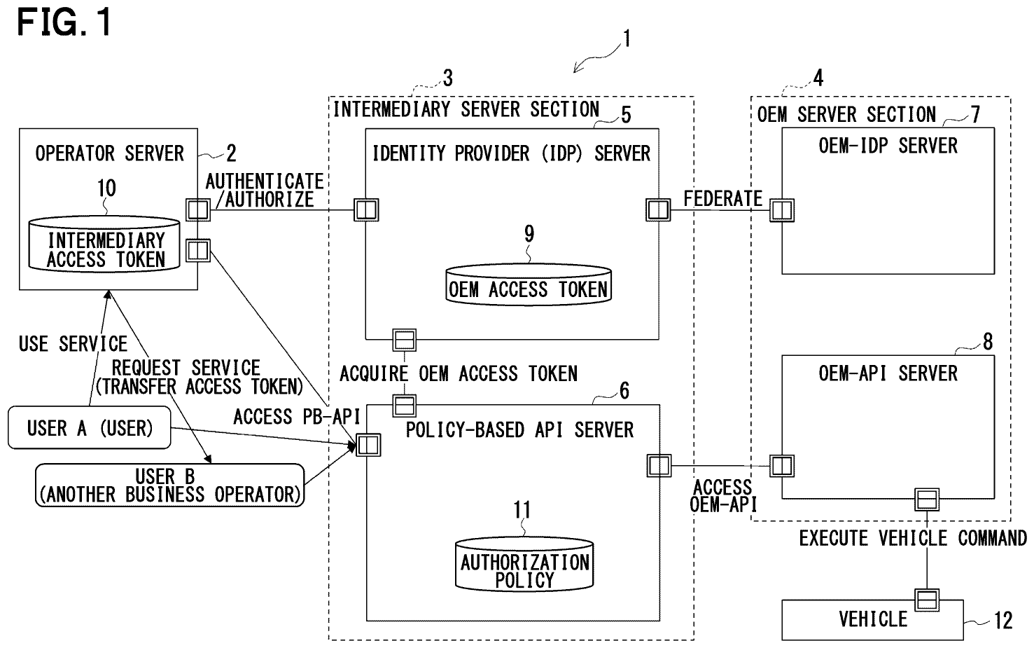

Hereinafter, a first embodiment will be described. As shown in FIG. 1, a vehicle utilization system 1 of the present embodiment includes an operator server 2, an intermediary server section 3, and an OEM server section 4. The operator server 2 accesses the intermediary server section 3 via the communication network, and the intermediary server section 3 similarly accesses the OEM server section 4 via the communication network. The operator server 2 is an example of an external server, and the intermediary server section 3 and the OEM server section 4 are examples of first and second servers, respectively.

In FIG. 1, for convenience of description, the operator server 2, the intermediary server section 3, and the OEM server section 4 are described as being separated, but for example, the intermediary server section 3 and the OEM server section 4 may be configured as one server. In addition, an identity provider (IDP) server 5 and a policy-based API server 6 included in the intermediary server section 3, and an OEM-IDP server 7 and the OEM-API server 8 included in the OEM server section 4, are also described as being separated for convenience of description, but may be configured as one server.

The vehicle utilization system 1 constructs the operator server 2 for a business operator to provide its own service, and accepts a service use request from a user. Hereinafter, the business operator is also referred to as a service operator or a service provider. The intermediary server section 3 includes the identity provider (IDP) server 5 and the policy-based API server 6. The OEM server section 4 includes the OEM-IDP server 7 and the OEM-API server 8. Hereinafter, when a “business operator” is simply referred to, this means a service operator that constructs the operator server 2 or operates the operator server 2. To “construct a server” includes constructing a server, operating a server, or providing a service through the use of a server.

The IDP server 5 is a server that is disclosed to the business operator described above by an intermediate business operator constructing the server 5. The IDP server 5 performs cooperation (federation) for authentication/authorization with the OEM-IDP server 7 and performs authentication/authorization with the operator server 2. In addition, when performing authentication/authorization with the operator server 2, the IDP server 5 stores an OEM access token issued by the OEM-IDP server 7 in a database 9, and issues an intermediary access token to be passed to the operator server 2. In the operator server 2, the intermediary access token is stored in a database 10. The intermediary access token corresponds to a first access token and the OEM access token corresponds to a second access token.

The operator server 2 and the user perform API access on the policy-based API server 6. The policy-based API server 6 is an API server for a business operator that discloses an API obtained by adding access control, based on a defined authorization policy, to the API disclosed by the OEM-API server 8. The “authorization policy” refers to a definition file that describes restriction contents of authorization, actions of authorization, and the like, and a program created from the definition file. The authorization policy is stored in a database 11 that is an example of a registration section. When API access is performed on the policy-based API server 6, an intermediary access token issued by the IDP server 5 at the time of authentication/authorization of the business operator or the user is required.

Here, to “disclose” refers to installing an interface so that software running on a server can input and output data to and from the outside of the software. In addition, to “install” described above does not refer to installing a physical device or the like, but means providing a means capable of accessing data handled by software or provision of a means for passing data.

For example, by installing an API in the server, that is, by disclosing an API, data can be easily input to software on the server from the outside of the server, or data can be easily output to the outside. For example, by inputting data via the API, software outside the server can acquire another data from the server via the API as a response.

In the vehicle utilization system 1 of the present embodiment, the intermediary server section 3 discloses an API to the operator server 2, and the OEM server section 4 discloses an API to the intermediary server section 3. The OEM server section 4 is assumed to disclose an API to the operator server 2 for the purpose of causing the service operator to construct a service. For the purpose of facilitating the service operator to construct the service, the intermediary server section 3 discloses the API only to the operator server 2 and accesses the API disclosed by the OEM server section 4.

The OEM-IDP server 7 is provided by a vehicle OEM, and issues and authorizes an OEM access token necessary for user authentication and the use of an OEM API. The OEM-API server 8 is a server for a business operator disclosed by the vehicle OEM. Prior to API access to the API server 8, the policy-based API server 6 requests the IDP server 5 to acquire the OEM access token corresponding to the intermediary access token. The IDP server 5 transfers the OEM access token stored in the database 9 to the policy-based API server 6. The policy-based API server 6 performs API access on the OEM-API server 8 along with the OEM access token. The OEM-API server 8 communicates with a vehicle 12 via the network and issues a command to the vehicle.

Examples of the commands to the vehicle include trunk unlock/lock, fuel cap or power port open, door open, and vehicle information acquisition. Upon receiving the door open command from the OEM-API server 8, the vehicle 12 performs ignition-on, steering unlocking, and security system release, in addition to door opening. This enables the user or a staff member of the service operator to drive the vehicle.

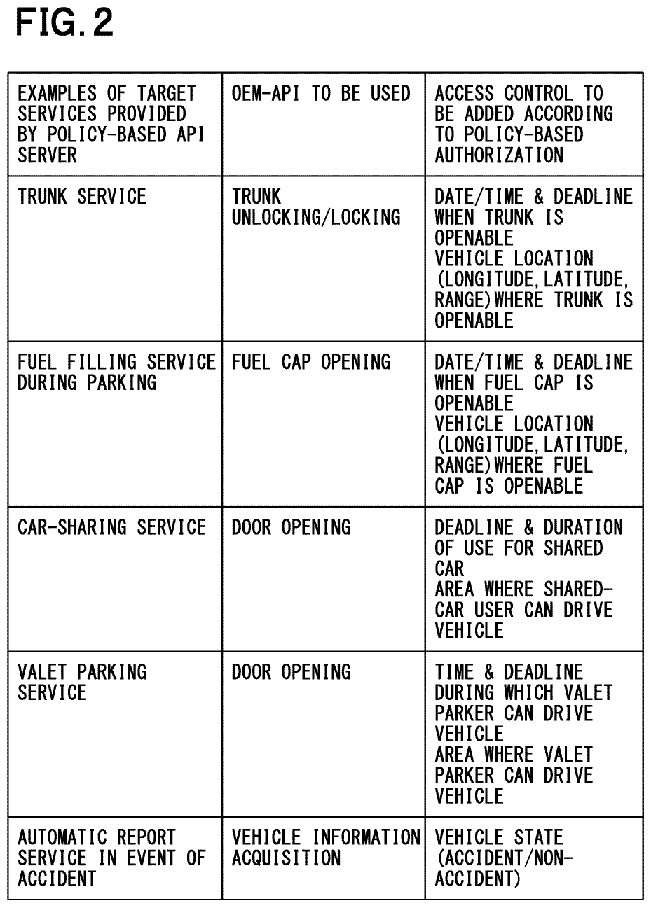

The business operator creates an authorization policy based on an authorization policy catalog shown in FIG. 2, and adds access control for a service provided by the policy-based API server 6, according to the authorization policy. For example, in the case of the “trunk service” for the vehicle, an OEM-API, which is a commonly used API, is “trunk unlock/lock”. In contrast, the access controls to be added according to the authorization policy include, for example, a date and time when, and a deadline when, the trunk is openable, the vehicle location (latitude, longitude, and range) where the trunk is openable, and the like. In the case of the “fuel filling service during parking”, the OEM API is “fuel cap open”. In contrast, the access controls to be added according to the authorization policy include a date and time when, and a deadline when, the fuel cap is openable, the vehicle location (latitude, longitude, and range) where the fuel cap is openable, and the like. Further, in the case of the “car-sharing service”, the OEM API is “door open”. In contrast, the access controls to be added according to the authorization policy include a deadline and duration of use for a shared car, an area in which the user can drive, and the like.

The authorization policy catalog is created by the business operator of the intermediary server section 3 and presented to the business operator of the operator server 2. The business operator of the operator server 2 references the authorization policy corresponding to the service content that the business operator intends to provide, and constructs the service. Alternatively, the business operator of the operator server 2 inquires with the business operator of the intermediary server section 3 about the service content intended to be provided, and constructs the service by grasping the authorization policy corresponding to the service. The intermediary server section 3 may or may not include the authorization policy catalog.

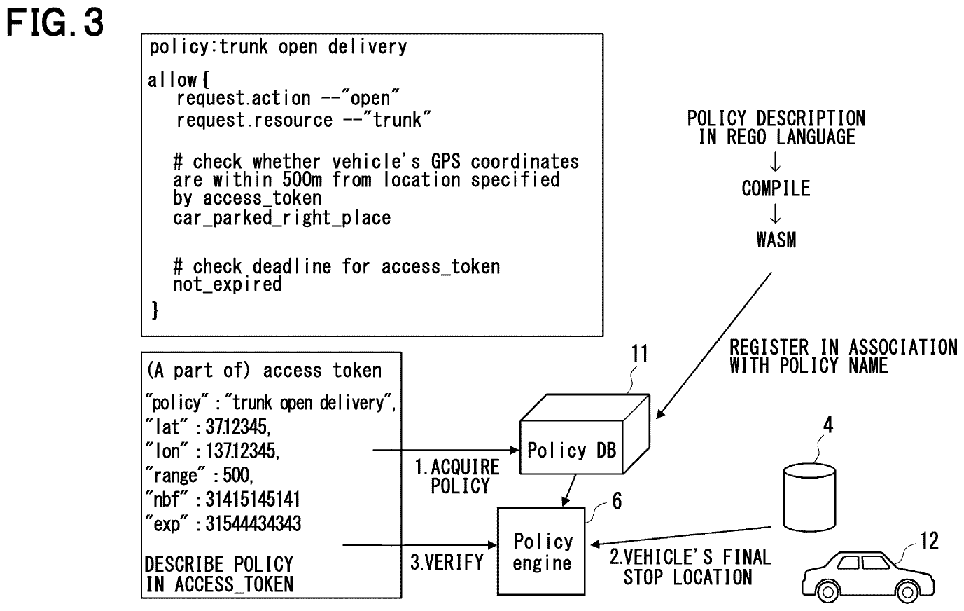

FIG. 3 shows a specific description example of the authorization policy of the “trunk service” and the outline of the process thereof. For example, an authorization policy described in the Rego language or a similar language is compiled, converted into WebAssembly (WASM), and registered in the database 11 with an associated policy name (trunk_open_delivery). The policy name is described in an access token, and the policy-based API server 6 acquires the authorization policy of the policy name from the database 11. When the final stop location of the vehicle 12 is acquired from the OEM server section 4, it is verified whether the location conforms to the authorization policy.

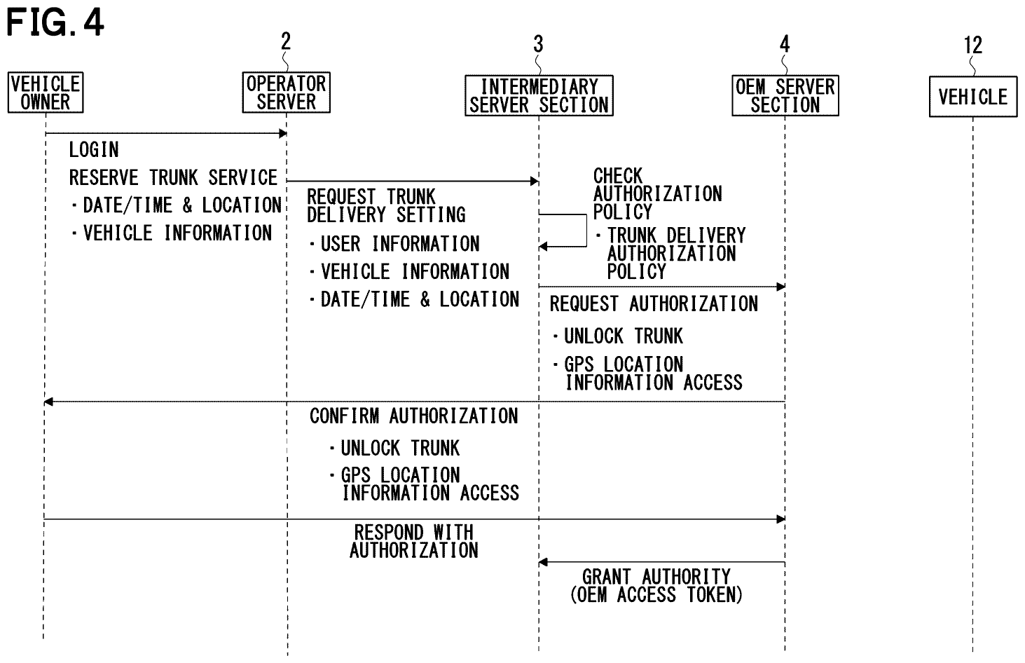

Next, the operation of the present embodiment will be described. As shown in FIG. 4, the owner of the vehicle 12 is registered in advance as a user in a service provided by the OEM, and has the authority to remotely issue a trunk unlocking request for the vehicle 12. The vehicle 12 is stopped at a location where the home delivery service is to be provided, and the service operator side acquires the location information of the vehicle 12 at the time of the service application and uses the location information to determine the condition for the trunk opening.

The owner of the vehicle 12 logs into the operator server 2 and reserves the trunk service. At that time, the service use date and time, as well as location, vehicle information, and the like, are input along with the user information. The user information may be acquired from information at the time of login, and information stored in the operator server 2 may be used as the vehicle information. Then, the operator server 2 transfers the information to the intermediary server section 3 and requests the setting of trunk delivery.

The intermediary server section 3 checks the authorization policy for the trunk delivery. For example,
Action upon authorization: trunk unlocking
Authorization conditions: the vehicle location is within a 500 m radius of the current location/MM/DD, from XX: XX to ZZ: ZZ,
and the like are checked. Then, an authorization request for the trunk unlocking and Global Positioning System (GPS) location information access is transmitted to the OEM server section 4. This functional portion corresponds to an authorization request section.

The OEM server section 4 confirms to the owner of the vehicle 12 whether to unlock the trunk and access the GPS location information. For example, a confirmation screen is displayed on a mobile terminal or the like of the user, indicating that the request is from the intermediary server section 3, and when the user accepts, that is, responds with authorization, an OEM access token is issued to grant authority to the intermediary server section 3. The OEM access token corresponds to the second access token.

In the example described above, the user of the vehicle 12 responds to the reservation or the confirmation request from the OEM server section 4 through the mobile terminal of the user. However, the user may respond to the reservation or the confirmation request through a car navigation system, an instrument panel, or a center display mounted on the vehicle instead of the mobile terminal.

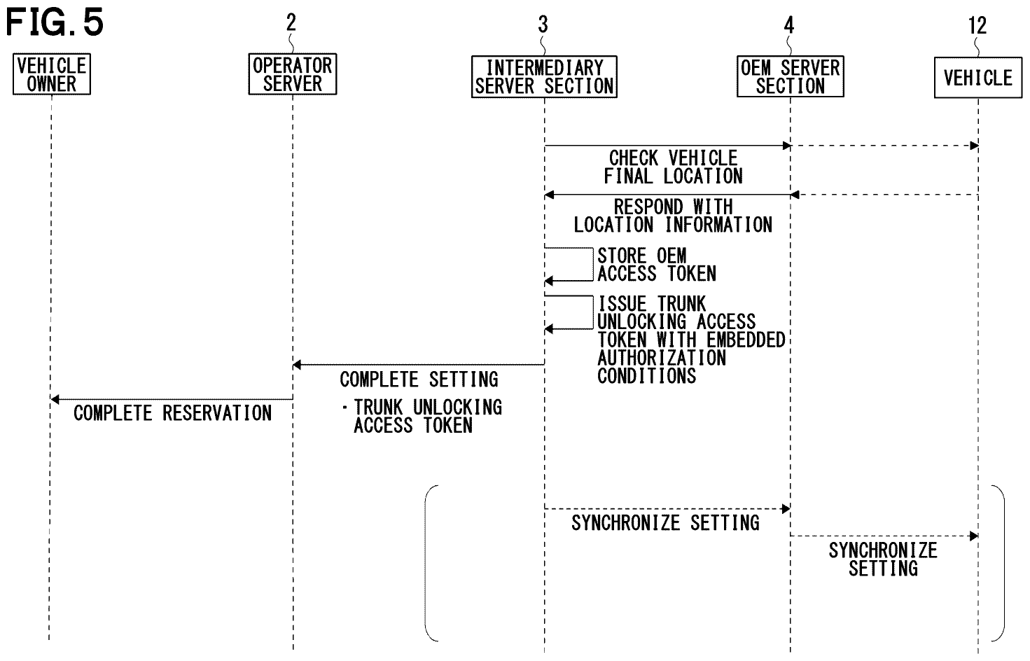

Subsequently, as shown in FIG. 5, the intermediary server section 3 requests the OEM server section 4 to check the final location of the vehicle 12. The OEM server section 4 communicates with the vehicle 12 and acquires the vehicle location at that time or the vehicle location stored when the vehicle was stopped. When obtaining a response regarding the location information from the OEM server section 4, the intermediary server section 3 stores the OEM access token in the database 9. Then, a trunk unlocking access token with embedded authorization conditions is generated. At this time, the trunk unlocking access token and the OEM access token are managed in association with each other. This functional portion corresponds to a first access token issuing section. The trunk unlocking access token is an example of an intermediary access token.

The intermediary server section 3 issues a trunk unlocking access token to the operator server 2 while notifying the setting completion. The trunk unlocking access token corresponds to the first access token. In response to this, the operator server 2 notifies the owner of the vehicle 12 that the reservation of the trunk service has been completed. A portion indicated by parentheses ( ) in the figure is a process assumed as an option, and here, the intermediary server section 3 may perform a setting synchronization process on the vehicle 12 via the OEM server section 4. At the time of unlocking the trunk, a command for requesting synchronization authorization or synchronization may be issued on the cloud.

Here, the trunk unlocking access token is an identifier used to access an API that executes a vehicle function controlled according to an execution condition defined by an authorization policy, and the OEM access token is an identifier used to access an API that executes a vehicle function access-controlled based on a predetermined user authentication coordination protocol. The user authentication coordination protocol conforms to, for example, OIDC/OAuth2.0.

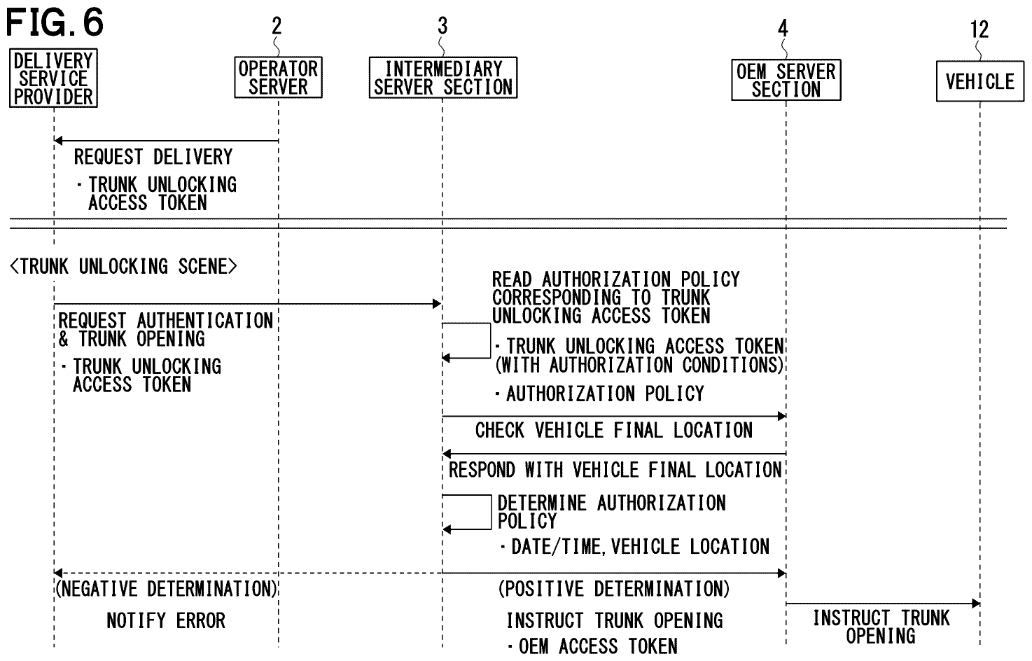

As shown in FIG. 6, thereafter, the operator server 2 issues a trunk unlocking access token to the delivery service provider to request the delivery service. At the time of actually unlocking the truck, the delivery service provider requests the intermediary server section 3 for the authentication and trunk unlocking along with transmission of the trunk unlocking access token.

The intermediary server section 3 reads the authorization policy corresponding to the trunk unlocking access token. The final location of the vehicle 12 at that time is checked with the OEM server section 4, and when a response is obtained, it is determined whether or not the date and time and the vehicle location conform to the authorization policy. When the determination result is “positive” in conformity with the authorization policy, the OEM access token is transmitted to the OEM server section 4, and the trunk opening is instructed. This functional portion corresponds to an execution instruction request section. In response to this, the OEM server section 4 instructs the vehicle 12 to open the trunk.

As described above, according to the present embodiment, in the vehicle utilization system 1, an authorization policy defining a vehicle function and a condition for executing the vehicle function is registered in advance in the intermediary server section 3. Upon receiving an authorization request for the vehicle function from the operator server 2 that provides a service along with an execution condition for the service, the intermediary server section 3 stores the execution condition and the authorization policy corresponding to the service in association with each other, and transmits the authorization request for the vehicle function to the OEM server section 4.

Upon accepting the authorization request, the OEM server section 4 obtains the authorization for the vehicle function and then issues an OEM access token to the intermediary server section 3. The intermediary server section 3 holds the OEM access token and issues, to the operator server 2, a trunk unlocking access token associated with the OEM access token, the execution condition, and the authorization policy.

Further, upon receiving a request for the execution of the service along with the trunk unlocking access token from the operator server 2 or a user who uses the service, the intermediary server section 3 determines whether or not the execution condition is satisfied according to the execution condition and the authorization policy associated with the trunk unlocking access token, and transmits to the OEM server section 4 a request for an execution instruction for the vehicle function along with the OEM access token when the execution condition is satisfied.

With this configuration, a business operator that provides a service using the operator server 2 as a user reception point can set a detailed execution condition for the service through the intermediary server section 3. Since the intermediary server section 3 intermediates the authorization request for the vehicle function to the OEM server section 4, the business operator providing the service does not need to perform a complex process in the operator server 2, and can easily develop the business.

### Second Embodiment

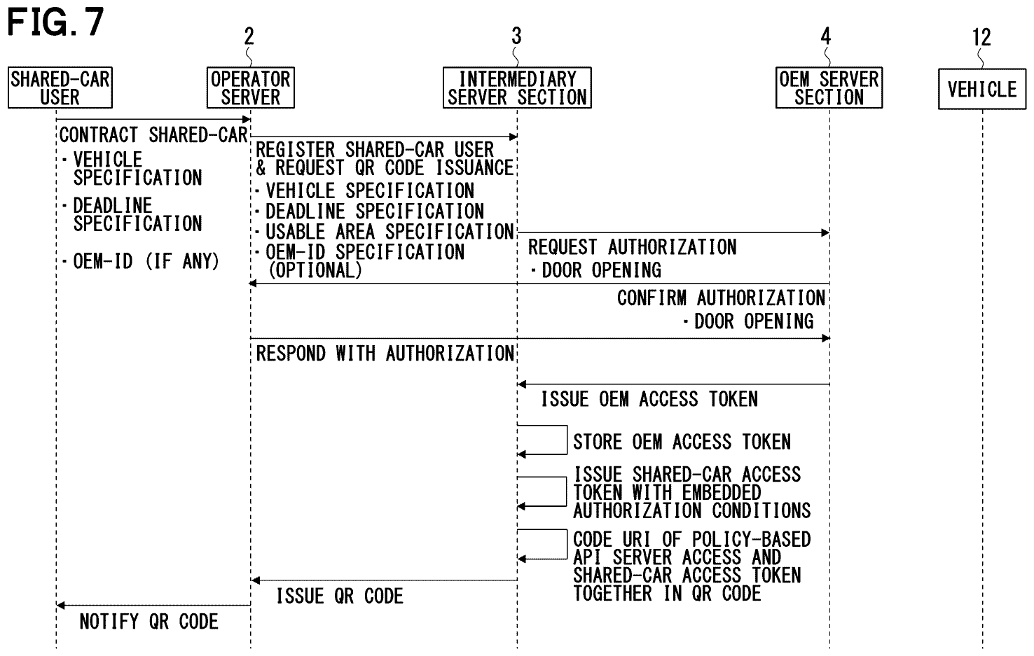

Hereinafter, portions equal to those in the first embodiment will be denoted by the equal reference numerals. The descriptions thereof will be omitted, and different portions will be described. A second embodiment describes the case of application to the car-sharing service. As shown in FIG. 7, a shared-car user who rents the vehicle 12 applies to operator server 2 for a shared-car contract. At that time, the vehicle 12 is specified as well as a deadline for its use. In addition, in a case where there is an ID from the OEM, the ID is also specified. The vehicle 12 used in the car-sharing service of the second embodiment will be described as a vehicle owned by a service operator.

Upon receiving the application for the contract, the operator server 2 requests the intermediary server section 3 to register the shared-car user and issue a QR code (registered trademark). At that time, vehicle information, deadline information, and an available area for the vehicle 12 are added to the information associated with the application, which is then transmitted. The intermediary server section 3 checks the authorization policy for the car-sharing service. Then, an authorization request for the door opening is transmitted to the OEM server section 4. In the second embodiment, the owner of the vehicle 12 is assumed to be the service operator that operates the operator server 2. Therefore, the OEM server section 4 confirms whether the door opening may be authorized with respect to the operator server 2.

When there is an authorization response from the operator server 2, the OEM server section 4 issues an OEM access token, which registers the shared-car user to open the door of the vehicle 12, to the intermediary server section 3. When storing the authorization policy and the OEM access token in association with each other, the intermediary server section 3 issues a shared-car access token with embedded authorization conditions. The shared-car access token is an example of an intermediary access token. When a uniform resource identifier (URI) for accessing the policy-based API server 6 and the shared-car access token are collectively converted into a QR code, the QR code is issued to the operator server 2. The operator server 2 notifies the shared-car user of the QR code.

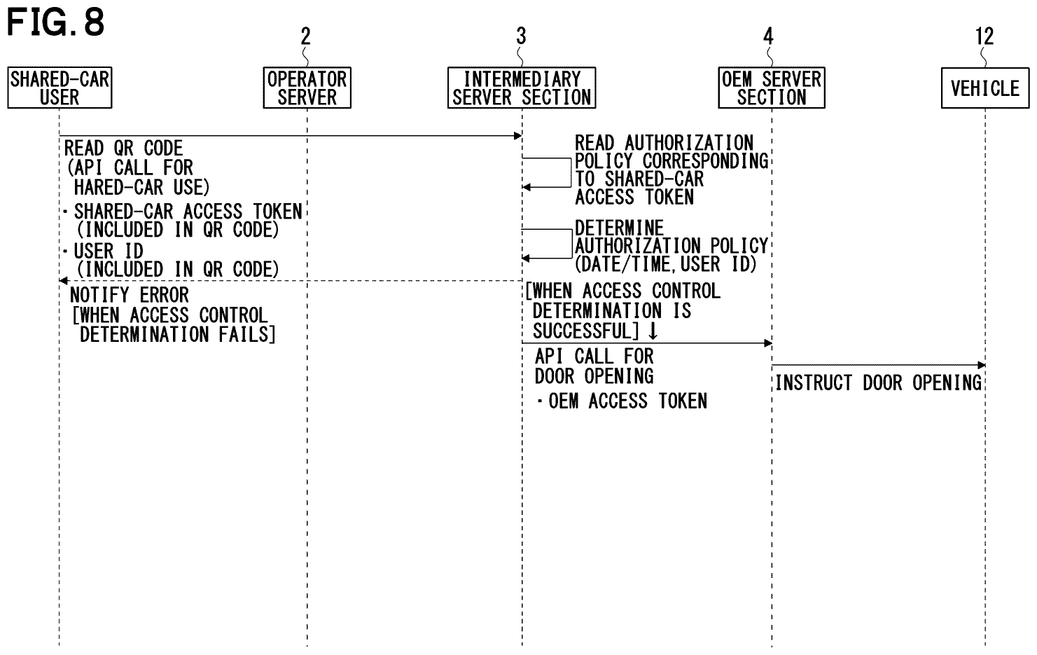

As shown in FIG. 8, the shared-car user reads the notified QR code, whereby an API call for the shared-car use is issued to the intermediary server section 3. The API call also includes the shared-car access token and the user identity. At this time, an operation screen for the vehicle 12 may be presented on a mobile terminal such as a smartphone owned by the shared-car user. For example, at the time of reading the QR code, a screen indicating functions such as the door opening and engine start is displayed.

The intermediary server section 3 reads the authorization policy corresponding to the shared-car access token. The use information, such as the authorization condition, date and time, and user ID included in the API call for the shared-car use, is compared with the authorization policy to make a determination. When the use information matches the authorization policy and the determination result is successful, the intermediary server section 3 transmits an API call instructing to open the door of the vehicle 12 to the OEM server section 4. Upon receiving the API call, the OEM server section 4 instructs the vehicle 12 to open the door. On the other hand, when the use information does not match the authorization policy and the determination result is failure, the intermediary server section 3 notifies the shared-car user of an error.

As described above, according to the second embodiment, the present disclosure can also be applied to a shared-car service.

### Other Embodiments

The external server is not limited to the operator server 2.

The content of the service related to the vehicle function and the authorization policy are not limited to those exemplified.

The use flows of the trunk service and the car-sharing service are not limited to those exemplified in the embodiment. Further, FIG. 2 show examples of target services provided by a policy-based API server, and the present disclosure is applicable to various services using the API provided by the OEM server section 4.

The user authentication coordination protocol related to the second access token is not limited to one conforming to OIDC/OAuth2.0.

In the above embodiment, the trunk service and the car-sharing service have been described as examples of the use of MaaS, but the vehicle utilization system of the present disclosure is applicable to other services (vehicle utilization services). In this case as well, the intermediary server section 3 checks the authorization policy when receiving user identity, vehicle information, and an authorization request from the operator server 2. Depending on the vehicle utilization service, the request from the operator server 2 to the intermediary server section 3 may not include at least one of the user identity, the vehicle information, and the authorization request, or may include another information or request. When the authorization policy is checked, the intermediary server section 3 requests an OEM server section 4 to issue the OEM access token for the authorization request. When the OEM server section 4 issues the OEM access token to the intermediary server section 3, the intermediary server section 3 issues an intermediary access token corresponding to the OEM access token, and transmits the intermediary access token to the operator server 2. When the operator server 2 or the service user uses the vehicle utilization service, the operator server 2 or the service user accesses the intermediary server section 3 using the intermediary access token issued in advance. The intermediary server section 3 determines whether or not the authorization policy is satisfied, and when the determination is positive, the intermediary server section 3 requests the OEM server section 4 to utilize the vehicle by using the OEM access token corresponding to the intermediary access token. The OEM server section 4 instructs the vehicle to perform an action corresponding to the OEM access token.

Although the present disclosure has been described according to the embodiments, it is understood that the present disclosure is not limited to the above-described embodiments or structures. The present disclosure includes various modification examples and equivalents thereof. In addition, various combinations and configurations, as well as other combinations and configurations that include only one element, more, or less, fall within the scope and spirit of the present disclosure.

Means and/or functions provided by each device or the like may be provided by software recorded in a tangible memory device and a computer that can execute the software, software only, hardware only, or some combination of them. For example, when the control device is provided by an electronic circuit that is hardware, it can be provided by a digital circuit including a large number of logic circuits, or an analog circuit.

The controller and the method thereof of the present disclosure may be implemented by a dedicated computer provided by configuring a processor and a memory programmed to execute one or more functions embodied by a computer program. Alternatively, the controller and the method described in the present disclosure may be implemented by a dedicated computer provided by forming a processor with one or more dedicated hardware logic circuits. Alternatively, the controller and the method described in the present disclosure may be implemented by one or more dedicated computers including a combination of a processor and a memory programmed to execute one or multiple functions and a processor including one or more hardware logic circuits. The computer program may also be stored on a computer-readable and non-transitory tangible storage medium as an instruction executed by a computer.

What is claimed is:

1. A vehicle utilization system comprising
a first server and a second server connected to each other via a communication network,
wherein:
an authorization policy defining a vehicle function and a condition for executing the vehicle function is registered in advance in the first server;
upon receiving an authorization request for the vehicle function from an external server that provides a service along with an execution condition for the service, the first server stores the execution condition and an authorization policy corresponding to the service in association with each other, and transmits the authorization request for the vehicle function to the second server;
upon accepting the authorization request, the second server obtains authorization for the vehicle function and then issues a second access token to the first server; and
the first server holds the second access token and issues, to the external server, a first access token associated with the second access token, the execution condition, and the authorization policy, and upon receiving a request for execution of the service along with the first access token from the external server or a user who uses the service, the first server determines whether the execution condition is satisfied according to the execution condition and the authorization policy associated with the first access token, and when the execution condition is satisfied, the first server requests the second server to instruct execution of the vehicle function along with the second access token.

2. The vehicle utilization system according to claim 1, wherein
the first server includes an application programming interface (API) that issues the first access token defined by the authorization policy associated with the service provided by the external server, and an API that executes a vehicle function controlled by the execution condition defined by the authorization policy, and
the second server includes an API that issues the second access token based on a predetermined user authentication coordination protocol, and an API that executes a vehicle function access-controlled by the second access token.

3. The vehicle utilization system according to claim 1, wherein
the first access token issued by the first server is an identifier used to access an application programming interface (API) that executes a vehicle function, controlled by an execution condition defined by the authorization policy, and
the second access token issued by the second server is an identifier used to access an API that executes a vehicle function, access-controlled based on a predetermined user authentication coordination protocol.

4. The vehicle utilization system according to claim 3, wherein
the predetermined user authentication coordination protocol is an authentication protocol conforming to OpenID Connect (OIDC)/OAuth 2.0.

5. The vehicle utilization system according to claim 1, wherein
a function of a vehicle, a date and time when the function is available, and a location of the vehicle where the function is available are set as the authorization policy in the first server.

6. The vehicle utilization system according to claim 1, wherein
a function of unlocking or locking a luggage compartment of the vehicle, a date and time when the function is executable, and a location of the vehicle where the function is executable are set as the authorization policy in the first server.

7. The vehicle utilization system according to claim 1, wherein
a function of opening a fuel cap or a charging port of a vehicle, a date and time when the function is executable, and a location of the vehicle where the function is executable are set as the authorization policy in the first server.

8. The vehicle utilization system according to claim 1, wherein
a function of enabling driving of the vehicle, a date and time when the function is executable, and an area where the driving is permitted are set as the authorization policy in the first server.

9. The vehicle utilization system according to claim 1, wherein
the second server, requested by the first server to instruct execution of the vehicle function along with the second access token, causes the vehicle to execute the function.

10. A first server of a vehicle utilization system, the first server being connected to a second server via a communication network, the first server comprising:
a registration section that registers in advance an authorization policy defining a vehicle function and a condition for executing the vehicle function;
an authorization request section that, upon receiving an authorization request for the vehicle function from an external server configured to provide a service along with an execution condition for the service, stores the execution condition and an authorization policy corresponding to the service in association with each other, and transmits the authorization request for the vehicle function to the second server;
a first access token issuing section that holds a second access token and issues, to the external server, a first access token associated with the second access token, the execution condition, and the authorization policy when the second server issues the second access token after accepting the authorization request and obtaining authorization for the vehicle function; and
an execution instruction request section that, upon receiving a request for execution of the service along with the first access token from the external server or a user who uses the service, determines whether the execution condition is satisfied according to the execution condition and the authorization policy associated with the first access token, and requests the second server to instruct execution of the vehicle function along with the second access token when the execution condition is satisfied.

11. A vehicle utilization method comprising:
registering in advance an authorization policy that defines a vehicle function and a condition for executing the vehicle function;
storing, upon receiving an authorization request for the vehicle function from an external server that provides a service along with an execution condition for the service, the execution condition and an authorization policy corresponding to the service in association with each other, and transmitting the authorization request for the vehicle function to a second server,
holding a second access token and issues, to the external server, a first access token associated with the second access token, the execution condition, and the authorization policy when the second server issues the second access token after accepting the authorization request and obtaining authorization for the vehicle function; and
defining, upon receiving a request for execution of the service along with the first access token from the external server or a user who uses the service, whether the execution condition is satisfied according to the execution condition and the authorization policy associated with the first access token, and requesting the second server to instruct execution of the vehicle function along with transmission of the second access token when the execution condition is satisfied.
